(19) United States
(12) Patent Application Publication
(10) Pub. No.: US 2026/0257865 A1
(43) Pub. Date: Sep. 3, 2026

(54) AUTOMATED GOODS SORTING SYSTEM

(71) Applicant: KNAPP AG, Hart bei Graz (AT)

(72) Inventors: Franz MATHI, Hart bei Graz (AT); Roland KOHOLKA, Hart bei Graz (AT)

(21) Appl. No.: 19/156,261

(22) PCT Filed: Nov. 16, 2023
(86) PCT No.: PCT/AT2023/060396

§ 371 Date: Aug. 13, 2025

(30) Foreign Application Priority Data
Feb. 14, 2023 (AT) A 50091/2023

(51) Int. Cl. B65G 17/34; B65G 43/08; B65G 47/46

(52) U.S. Cl. CPC B65G 17/345; B65G 43/08; B65G 47/46

(57) ABSTRACT

An automated goods sorting system including a travelling path and transverse sorting units coupled to one another to form a transverse sorting unit train, and each of the transverse sorting units delivers goods to goods receiving positions along the travelling path, two of the transverse sorting units include electrical pick-up contacts, which establish an electrical line connection with supply contacts positioned along the travelling path, the supply contacts are only provided in sections along the travelling path, the transverse sorting units of the transverse sorting unit train are electrically connected, and a distance along the travelling path between two supply contacts and a length of the supply contacts along the travelling path are such that, during travel of the transverse sorting unit train, the pick-up contacts of one transverse sorting unit of the transverse sorting unit train are at all times in an electrical line connection with supply contacts.

### BACKGROUND

The invention relates to an automated goods sorting system according to the preamble of claim 1.

Automated goods sorting systems are used in the field of warehouse logistics to compile orders or deliveries from a large number of products, which are usually stored in a rack storage system. Depending on the design of the specific warehouse, such sorting systems may comprise transverse belt sorters, also known as transverse sorting units, wherein individual goods are transported along a travelling path by means of these transverse belt sorters and then conveyed essentially transversely to this travelling path to various goods receiving positions. The advantage of such systems is that they allow a high throughput of goods, have a robust design and are cost-effective compared to systems that use individual independent transport shuttles. In the state of the art, the transverse belt sorters may be operated using various methods. For example, the transverse belt sorters may be equipped with a dynamo, wherein the dynamo generates electrical current during the movement of the individual transverse belt sorters along the travelling path, which is used to operate an electric motor of the respective transverse belt sorter. For example, the transverse belt sorters can be equipped with a dynamo, whereby the dynamo generates electrical current during the movement of the individual transverse belt sorters along the track, which is used to drive an electric motor of the respective transverse belt sorter. Alternatively, the transverse belt sorters may also be driven mechanically, for example with a friction wheel or a shift gate. Another option is to externally supply an electric motor of a transverse belt sorter with electric power. The configuration of the transverse belt sorter with an electric motor has the advantage that the electric motor enables precise control and complex movement sequences of the individual transverse belt sorters.

A goods sorting system using transverse belt sorters is known, for example, from EP 1 352 858 A2.

A disadvantage of such systems known from the prior art, which have transverse belt sorters with electric motors and an external power supply, is that the transverse belt sorters must be continuously supplied with power during their movement along the travelling path. This is conventionally realised by sliding contacts, which are in contact with conductor rails arranged along the travelling path. These sliding contacts, as well as the conductor rails themselves, are subject to continuous mechanical wear during operation, which means that they have to be replaced regularly. This increases the operating costs and maintenance requirements of such systems. In addition, it also increases the time required to maintain such systems, rendering the system not available during this period.

### BRIEF SUMMARY

The object of the present invention is to overcome these disadvantages of the prior art.

According to the invention, this object is solved by providing an automated goods sorting system with the features of claim 1.

The goods sorting system according to the invention comprises a travelling path and a plurality of transverse sorting units, which may be moved along the travelling path. The transverse sorting units are coupled to one another in a row along the travelling path to form at least one transverse sorting unit train, wherein each of the transverse sorting units is configured to deliver goods essentially transversely to a direction of travel along the travelling path to goods receiving positions arranged along the travelling path.

At least two of the transverse sorting units of the transverse sorting unit train comprise electrical pick-up contacts, which are configured to establish an electrical line connection with supply contacts positioned along the travelling path, wherein the supply contacts are only provided in some sections along the travelling path.

According to the invention, the transverse sorting units of the transverse sorting unit train are electrically connected, and a distance along the travelling path between two supply contacts and a length of the supply contacts along the travelling path are selected such that, during travel of the transverse sorting unit train along the travelling path, the pick-up contacts of at least one transverse sorting unit of the transverse sorting unit train are essentially at all times in an electrical line connection with supply contacts along the travelling path.

The arrangement of the supply contacts along the travelling path, their length along the travelling path as well as the selection of the position of the transverse sorting units within the transverse sorting unit train, which have pick-up contacts, will ensure that at least the pick-up contacts of one transverse sorting unit of the transverse sorting unit train are essentially in contact with the supply contacts along the travelling path at all times. Due to the electrical connection between the transverse sorting units it will be ensured that all transverse sorting units are continuously being supplied with power. This has the advantage that the mechanical wear of the power supply system of the automated goods sorting system according to the invention that occurs at the supply contacts and pick-up contacts is greatly reduced.

The travelling path and the at least one transverse sorting unit train preferably each form a self-contained loop. In this way, the entire travelling path is occupied by transverse sorting units, which increases the overall capacity of the goods sorting system according to the invention.

Preferably, the supply contacts are connected to a control unit, and the control unit is configured to electively supply the supply contacts with one of several different primary voltage levels. This has the advantage that the supply voltage of the goods sorting system, which is applied to the supply contacts, may be adapted to the requirements of the transverse sorting unit train.

According to the preferred embodiment variant of the goods sorting system according to the invention, at least one transverse sorting unit of the transverse sorting unit train has an energy management unit, wherein the energy management unit comprises an energy storage unit. This has the advantage that short interruptions in the power supply via the supply contacts and pick-up contacts may be bridged and the transverse sorting units may continue to be operated.

The energy management unit preferably comprises train control electronics, wherein the train control electronics is connected to the transverse sorting units of the transverse sorting unit train and is configured to control the transverse sorting units as a function of the primary voltage level. This makes it possible to control the transverse sorting units of the transverse sorting unit train by selecting the primary voltage level, without the need for additional data transmission to the transverse sorting units.

Preferably, the energy management unit comprises a voltage transformer. In this way, a constant operating voltage may be provided to the transverse sorting units even if the primary voltage level at the supply contacts fluctuates.

According to the preferred embodiment variant of the goods sorting system according to the invention, the train control electronics is configured to switch off the transverse sorting units after a predetermined time at a first primary voltage level. In this way, it is ensured that the transverse sorting units may complete an operation that has already started and that no mechanical blockage of the goods sorting system occurs when the system is switched off, which could require manual intervention when the system is restarted.

The train control electronics is preferably configured to switch off the transverse sorting units immediately at a second primary voltage level. In this way, the selection of the primary voltage level may be used to perform an emergency shutdown.

Furthermore, the train control electronics may be configured to move the transverse sorting units into an operating state at a third primary voltage level. In this way, the automated goods sorting system according to the invention may be put back into operation after it has been switched off.

Preferably, the transverse sorting units each comprise at least one conveyor belt orientated essentially transverse to the direction of travel. This provides a low-wear, robust and cheap option for conveying the goods to the goods receiving positions.

According to the preferred embodiment variant of the goods sorting system according to the invention, the transverse sorting units of the transverse sorting unit train are connected to a data link running through the transverse sorting unit train, wherein at least one of the transverse sorting units of the transverse sorting unit train has a data interface connected to the data link.

The data interface is preferably configured to control each of the transverse sorting units as a function of the position of the transverse sorting unit along the travelling path. In this way, the delivery of the goods to the goods receiving positions is controlled during the travel of the transverse sorting unit train along the travelling path.

Preferably, each of the transverse sorting units has an inertial measuring unit connected to the data interface. This allows vibrations and impacts occurring on the transverse sorting units to be detected. This allows conclusions to be drawn about the function and condition of the running gear of the individual transverse sorting units. Furthermore, the weight of goods transported on the respective transverse sorting unit may be determined.

### BRIEF DESCRIPTION OF THE DRAWINGS

Advantageous embodiments of the automated goods sorting system according to the invention, as well as alternative embodiment variants, are explained in greater detail below with reference to the figures.

FIG. 1 shows a schematic view of the automated goods sorting system according to the invention.

### DETAILED DESCRIPTION

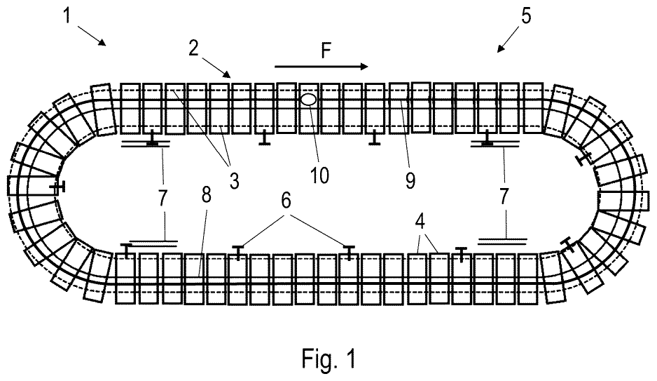

The automated goods sorting system 1 according to the invention is shown in FIG. 1 in a schematic view from above. It comprises a travelling path 2, which is preferably self-contained as shown in FIG. 1. The travelling path 2 usually follows a complex course, for example through a warehouse, but is shown in FIG. 1 in the form of an essentially elliptical loop for simpler visualisation. The travelling path 2 may, for example, comprise a rail system 3, which is shown as a dashed line in FIG. 1. The automated goods sorting system 1 according to the invention further comprises a plurality of transverse sorting units 4 that may be moved along the travelling path 2, which are shown in FIG. 1 using stylised rectangles. These transverse sorting units 4 are coupled to one another in a row along the travelling path 2 to form at least one transverse sorting unit train 5. As shown in FIG. 1, the transverse sorting unit train 5 may be self-contained and occupy the entire travelling path 2, or alternatively only occupy a part of the travelling path 2. This means that the travelling path 2 and the transverse sorting unit train 5 may each form a self-contained loop.

Several separate transverse sorting unit trains 5 may also be provided on the travelling path 2. Each of the transverse sorting units 4 is configured to deliver goods not shown in the figures essentially transversely to a direction of travel F along the travelling path 2, which is marked with an arrow in FIG. 1, to goods receiving positions arranged along the travelling path 2, which are also not shown in the figures. At least two of the transverse sorting units 4 of the transverse sorting unit train 5 comprise electrical pick-up contacts 6, which are configured to establish an electrical line connection with supply contacts 7 positioned along the travelling path 2. According to the invention, the supply contacts 7 are only provided in sections along the travelling path 2 and are configured, for example, as busbars, wherein the pick-up contacts 6 are configured, for example, as sliding contacts.

As shown in FIG. 1, the transverse sorting units 4 of the transverse sorting unit train 5 are electrically connected in accordance with the invention. This electrical connection 8 is shown in FIG. 1 by means of a continuous line, which represents an electrical supply line that is carried along with the transverse sorting unit train 5 and runs along the entire sorting unit train 5. This ensures that all sorting units 4 may be supplied with power. A distance along the travelling path 2 between two supply contacts 7 and a length of the supply contacts 7 along the travelling path 2 is selected according to the invention in such a way that, during a travel of the transverse sorting unit train 5 along the travelling path 2, the pick-up contacts 6 of at least one transverse sorting unit 4 of the transverse sorting unit train 5 are in an electrical line connection with supply contacts 7 along the travelling path 2 essentially at all times. This ensures that there is an electrical line connection between the pick-up contacts 6 of at least one transverse sorting unit 4 of the transverse sorting unit train 5 and the supply contacts 7 along the travelling path 2 at all times, and that the transverse sorting units 4 are continuously supplied with power via the electrical connection 8 to one another. Due to the configuration of the supply contacts 7, the pick-up contacts 6 and the electrical connection 8 between the transverse sorting units 4 according to the invention the mechanical wear on the electrical components of the goods sorting system 1 will be significantly reduced.

According to the preferred embodiment variant of the automated goods sorting system 1 according to the invention, the supply contacts 7 are connected to a control unit, which is not shown in the figures. The control unit is configured to electively supply the supply contacts 7 with one of several different primary voltage levels. For example, primary voltage levels of 0V, 24V and 48V may be provided. In this way, there is the advantage that the primary voltage of the goods sorting system 1, which is applied to the supply contacts 7, may be adjusted to the requirements of the transverse sorting unit train 5. Furthermore, at least one transverse sorting unit 4 of the transverse sorting unit train 5 may also have an energy management unit that is not shown in the figures, wherein the energy management unit may comprise an energy storage unit. The energy storage unit, for example in the form of an accumulator, may be used to compensate for brief interruptions in the power supply in the primary voltage. An energy management unit may be provided, for example, on those transverse sorting units 4 that also comprise pick-up contacts 6. Preferably, the transverse sorting unit train may also comprise several energy management units, which each have at least one energy storage unit. According to this embodiment variant, the energy management units are all connected to each other via the electrical connection of the transverse sorting units 4 of the transverse sorting unit train 5 with the respective supply contacts 7.

According to the preferred embodiment of the goods sorting system 1 according to the invention, the energy management unit comprises train control electronics. The train control electronics is connected to the transverse sorting units 4 of the transverse sorting unit train 5 and is configured to control the transverse sorting units 4 as a function of the primary voltage level currently applied to the supply contacts 7. This makes it possible to control the transverse sorting units 4 of the transverse sorting unit train 5 by selecting the primary voltage level, without the need for additional, separate data transmission to the transverse sorting units 4. In this way, the overall complexity of the goods sorting system 1 is reduced, thereby reducing its manufacturing costs.

Preferably, the energy management unit comprises a voltage transformer, which is not shown separately in the figures. The voltage transformer may, for example, ensure that the transverse sorting units 4 are supplied with a constant voltage of, for example, 58V, regardless of the primary voltage level. Furthermore, this may achieve a constant charging voltage for the energy storage unit.

According to the preferred embodiment variant, the different primary voltage levels may be used, as described above, to control the transverse sorting units 4 of the transverse sorting unit train 5 in a targeted manner by means of the train control electronics of the energy management unit. For example, three different primary voltage levels may be defined here.

Each of the primary voltage levels may subsequently be used to execute a specific action of the transverse sorting units 4 by means of the train control electronics. Preferably, the train control electronics is configured to switch off the transverse sorting units 4 after a predetermined time at a first primary voltage level. The first primary voltage level may be 0V, for example. This means that in the event of a loss of primary voltage, such as a power failure, the transverse sorting units 4 may still complete the actions they were performing at the time of the power failure. The energy required for this may be retrieved from the energy storage unit, for example. This offers the advantage that the transverse sorting units 4 will not be interrupted in the middle of an operation, which could result in the fact that they can only be restarted after manual intervention.

Furthermore, the train control electronics may preferably be configured to switch off the sorting units 4 immediately at a second primary voltage level. The second primary voltage level may be selected to be 24V, for example. By selecting the second primary voltage level, an external emergency shutdown may thus be performed. In addition, at a third primary voltage level, for example at 48V, the train electronics may be configured to put transverse sorting units 4 into an operating state. In this way the operation may be resumed by selecting the third primary voltage level.

Preferably, the transverse sorting units 4 each comprise at least one conveyor belt orientated essentially transverse to the direction of travel F. Alternatively, the transverse sorting units 4 may also comprise tilting trays or other goods manipulation devices. In this way, there may be the advantage that goods with very different properties may be handled using the transverse sorting units 4.

According to the preferred embodiment variant of the automated goods sorting system 1 according to the invention, the transverse sorting units 4 of the transverse sorting unit train 5 are connected to a data line 9 running through the transverse sorting unit train 5. The data line 9 is shown in FIG. 1 by a line running through the sorting unit train 5 and may be realised, for example, by means of an Ethernet connection. Preferably, at least one of the transverse sorting units 4 of the transverse sorting unit train 5 also has a data interface 10 connected to the data line 9. Alternatively, several data interfaces 10 may also be provided on different transverse sorting units 4 of the transverse sorting unit train 5. The data interface 10 may, for example, comprise a WLAN interface, which is connected to the Ethernet connection between the transverse sorting units 4. Alternatively, the data interface 10 may also comprise a powerline interface. By providing the data interface 10 and the data line 9, there is the advantage that the operations of the individual transverse sorting units 4 of the transverse sorting unit train 5 may be controlled in a targeted manner. Preferably, the data interface 10 is configured to control each of the transverse sorting units 4 as a function of the position of the transverse sorting unit along the travelling path 2. For this purpose, the data interface may comprise a transverse sorting control unit, and/or be configured to establish a data connection with an external transverse sorting control unit. This allows the transverse sorting units 4 to perform a specific operation based on their current position along the travelling path 2. In particular, the data interface is configured to transmit position-specific instructions to each of the transverse sorting units 4, which are executed by the respective transverse sorting unit 4 once the specified position is reached. This is particularly advantageous when real-time communication via the data interface between the transverse sorting control unit and transverse sorting unit 4 is not feasible. However, a safety-oriented control of the entire transverse sorting unit train 5 is preferably realised, as described above, by selecting an appropriate primary voltage level.

Furthermore, at least one, or preferably each of the transverse sorting units 4 may comprise an inertial measuring unit connected to the data interface 10, which is not visible in the figures. In this way, for example, there may be detected vibrations occurring during operation at the transverse sorting units 4, which may indicate a potential fault in the goods sorting system 1. Additionally, the inertial measuring unit may be used to determine the weight of goods present on a transverse sorting unit 4.

1-13. (canceled)

14. An automated goods sorting system comprising a travelling path and a plurality of transverse sorting units, which may be moved along the travelling path, wherein the transverse sorting units are coupled to one another in a row along the travelling path to form at least one transverse sorting unit train, and wherein each of the transverse sorting units is configured to deliver goods essentially transversely to a direction of travel along the travelling path to goods receiving positions arranged along the travelling path, and wherein at least two of the transverse sorting units of the transverse sorting unit train comprise electrical pick-up contacts, which are configured to establish an electrical line connection with supply contacts positioned along the travelling path, wherein the supply contacts are only provided in sections along the travelling path,
wherein the transverse sorting units of the transverse sorting unit train are electrically connected, and a distance along the travelling path between two supply contacts and a length of the supply contacts along the travelling path is selected in such a way that, during travel of the transverse sorting unit train along the travelling path, the pick-up contacts of at least one transverse sorting unit of the transverse sorting unit train are at all times in an electrical line connection with supply contacts, and the supply contacts are connected to a control unit, and that the control unit is configured to supply the supply contacts electively with one of several different primary voltage levels, wherein at least one transverse sorting unit of the transverse sorting unit train has an energy management unit, wherein the energy management unit comprises an energy storage unit and that the energy management unit comprises train control electronics, wherein the train control electronics is connected to the transverse sorting units of the transverse sorting unit train and that it is configured to control the transverse sorting units as a function of the primary voltage level.

15. The automated goods sorting system according to claim 14, wherein the travelling path and the at least one transverse sorting unit train each form a self-contained loop.

16. The automated goods sorting system according to claim 14, wherein the energy management unit comprises a voltage transformer.

17. The automated goods sorting system according to claim 14, wherein the train control electronics is configured to switch off the transverse sorting units after a predetermined time at a first primary voltage level.

18. The automated goods sorting system according to claim 14, wherein the train control electronics is configured to switch off the transverse sorting units immediately at a second primary voltage level.

19. The automated goods sorting system according to claim 14, wherein the train control electronics are designed to move the transverse sorting units into an operating state at a third primary voltage level.

20. The automated goods sorting system according to claim 14, wherein the transverse sorting units each comprise at least one conveyor belt oriented substantially transversely to the direction of travel.

21. The automated goods sorting system according to claim 14, wherein the transverse sorting units of the transverse sorting unit train are connected to a data link running through the transverse sorting unit train, wherein at least one of the transverse sorting units of the transverse sorting unit train has a data interface connected to the data link.

22. The automated goods sorting system according to claim 21, wherein the data interface is configured to control each of the transverse sorting units as a function of the position of the transverse sorting unit along the travelling path.

23. The automated goods sorting system according to claim 21, wherein at least one each of the transverse sorting units has an inertial measuring unit connected to the data interface.

24. The automated goods sorting system according to claim 15, wherein the transverse sorting units each comprise at least one conveyor belt oriented substantially transversely to the direction of travel.

25. The automated goods sorting system according to claim 16, wherein the transverse sorting units each comprise at least one conveyor belt oriented substantially transversely to the direction of travel.

26. The automated goods sorting system according to claim 17, wherein the transverse sorting units each comprise at least one conveyor belt oriented substantially transversely to the direction of travel.

27. The automated goods sorting system according to claim 18, wherein the transverse sorting units each comprise at least one conveyor belt oriented substantially transversely to the direction of travel.

28. The automated goods sorting system according to claim 19, wherein the transverse sorting units each comprise at least one conveyor belt oriented substantially transversely to the direction of travel.

29. The automated goods sorting system according to claim 15, wherein the transverse sorting units of the transverse sorting unit train are connected to a data link running through the transverse sorting unit train, wherein at least one of the transverse sorting units of the transverse sorting unit train has a data interface connected to the data link.

30. The automated goods sorting system according to claim 16 wherein the transverse sorting units of the transverse sorting unit train are connected to a data link running through the transverse sorting unit train, wherein at least one of the transverse sorting units of the transverse sorting unit train has a data interface connected to the data link.

31. The automated goods sorting system according to claim 17, wherein the transverse sorting units of the transverse sorting unit train are connected to a data link running through the transverse sorting unit train, wherein at least one of the transverse sorting units of the transverse sorting unit train has a data interface connected to the data link.

32. The automated goods sorting system according to claim 18, wherein the transverse sorting units of the transverse sorting unit train are connected to a data link running through the transverse sorting unit train, wherein at least one of the transverse sorting units of the transverse sorting unit train has a data interface connected to the data link.

33. The automated goods sorting system according to claim 19, wherein the transverse sorting units of the transverse sorting unit train are connected to a data link running through the transverse sorting unit train, wherein at least one of the transverse sorting units of the transverse sorting unit train has a data interface connected to the data link.
